(19) United States
(12) Patent Application Publication
(10) Pub. No.: US 2019/0184929 A1
(43) Pub. Date: Jun. 20, 2019

(54) SIDE-CURTAIN AIRBAG

(71) Applicant: FORD GLOBAL TECHNOLOGIES, LLC, Dearborn, MI (US)

(72) Inventors: Marcus John Scott WARD, Billericay (GB); Barry GRINDLE, Saffron Walden Essex (GB); Michal Jan SWINIARSKI, Brentwood Essex (GB)

(73) Assignee: FORD GLOBAL TECHNOLOGIES, LLC, Dearborn, MI (US)

(21) Appl. No.: 16/215,798

(22) Filed: Dec. 11, 2018

(30) Foreign Application Priority Data
Dec. 19, 2017 (GB) 1721336.4

(51) Int. Cl. B60R 21/231; B60R 21/213; B60R 21/233

(52) U.S. Cl. CPC B60R 21/23138; B60R 2021/0006; B60R 21/233; B60R 21/213

(57) ABSTRACT

A side-curtain airbag for motor vehicles has cushion that, when inflated, is positioned in spaced alignment with a side window. At least one spacer is located at a distal end of the cushion and is in fluid communication therewith. The spacer contacts a portion of the vehicle structure adjacent to the window and positions the cushion in the desired spaced relationship with the side window. The disclosed airbag provides greater resistance to impact and thereby reduces the distance of travel of the head of a motor vehicle occupant beyond the side window glass during a side impact collision.

### CROSS-REFERENCE TO RELATED APPLICATIONS

This application claims foreign priority benefits under 35 U.S.C. § 119(a)-(d) to GB Application 1721336.4 filed Dec. 19, 2017, which is hereby incorporated by reference in its entirety.

### TECHNICAL FIELD

The invention relates to a side-curtain airbag for motor vehicles, in particular a side-curtain bag which provides greater resistance to impact and thereby reduces the distance of travel of the head of a motor vehicle occupant beyond the side window glass during a side impact collision.

### BACKGROUND

A side-curtain airbag is designed to cover the side window glass of a motor vehicle in the event of a side impact collision, and operate in conjunction with other airbags such as driver airbags, passenger airbags, side (torso) airbags, and knee airbags. A side-curtain airbag normally deploys from under the roof lining and hangs curtain-like from the roof when inflated. Side-curtain airbags aim to prevent ejection of motor vehicle occupants or their limbs from the cabin, or intrusion of debris, such as broken glass or flying metal, into the cabin, thereby to reduce injuries such as broken bones, cuts or bruises.

The airbag normally deploys for less than a second, but when the motor vehicle is rolling over, some can deploy for several seconds to compensate for the additional time the motor vehicle occupants are at risk.

A side-curtain airbag has been designed for convertible motor vehicles which deploys from the sill of the door with the bottom of the airbag remaining secured to the sill of the door. The term “sill” is used, in this specification, to denote the region of the door at the base of the window.

Airbags are manufactured from a flexible but airtight fabric such as nylon or polyester, and operate with a sensor which triggers a gas inflator to inflate the airbag under collision conditions. All airbags have vents which allow the gas to escape after deployment.

DE 10 2009 021 045 discloses a side airbag comprising two inflatable impact protection cushions where one of the cushions is laterally fastened to a backrest below a lining and the other cushion is laterally fastened to a motor vehicle seat below another lining. Each cushion is filled with gas by a gas generator through appropriate gas filler openings. A rope is fastened to the seat and the backrest such that a banana-shaped cross section is formed toward a vehicle center. A seat belt is attached below the rope in transition from the seat to the backrest in a resting condition. The side airbag is suited to protect the torso from a side impact collision.

US 2011/0215557 discloses a side airbag for a motor vehicle including an outboard panel having a perimeter edge and a first vertical length, and an inboard panel having a perimeter edge and a second vertical length shorter than the first vertical length, the inboard and outboard panels joined to one another around their respective perimeter edges to form an enclosed volume such that when the airbag is inflated a mid-thickness line is concave toward the inboard panel. When the inflated airbag is positioned between an occupant seat and a side wall of the vehicle, the inboard-curved shape provides early engagement between an occupant of the seat and the airbag to offer improved protection for the head and neck. According to paragraph [0026] of US 2011/0215557, computer modelling and other testing has indicated that a side airbag with an inboard-curved shape may reduce levels of tension and/or shear forces experienced by the occupant's neck in a side impact collision.

KR 2013 0008338 discloses a side airbag module for a car seat comprising an airbag, an inflator, and a deployment shape maintaining member. The airbag is installed at one side of a back rest of a vehicle seat. The inflator deploys the airbag by supplying gas to the airbag. The deployment shape maintaining member bulbously maintains the airbag towards a passenger.

### SUMMARY

The invention provides a side-curtain airbag for a motor vehicle which is deployable from a roof of the motor vehicle or a passenger door of the motor vehicle, the airbag comprising a first inflatable portion (also referred to herein as a cushion) configured when inflated to cover and be in spaced alignment with side window glass of at least one passenger door.

A side-curtain airbag, deployable from a roof of the motor vehicle or a passenger door of the motor vehicle, is designed to cover the side window glass of a motor vehicle in the event of a side impact collision and prevents, on the one hand, ejection of motor vehicle occupants or their limbs from the cabin, and on the other, intrusion of broken glass or flying metal into the cabin, thereby to reduce injuries such as broken bones, cuts or bruises sustained by the motor vehicle occupants.

The side-curtain airbag of the invention is designed, when inflated, to not only cover but additionally be offset away from the side window glass into the interior of the motor vehicle cabin, thereby to minimize lateral head travel on side impact collision, in particular lateral head travel beyond the plane of the side window glass. Thus the term “spaced alignment” means, in this specification, that the first inflatable portion is offset from but still covering or in front of the window glass.

The invention provides a side-curtain airbag for a motor vehicle which is deployable from a roof of the motor vehicle or a passenger door of the motor vehicle, the airbag comprising a first inflatable portion, or cushion, configured when inflated to cover and be in spaced alignment with side window glass of at least one passenger door.

The term “vertical length” means, in this specification, the length of the outboard panel from top to bottom as measured along its surface when the airbag is inflated.

The first inflatable portion, or cushion, can comprise an outboard panel having a first perimeter edge and a first vertical length and an inboard panel having a second perimeter edge and a second vertical length, the outboard and inboard panels joined together around their first and second perimeter edges thereby to form an enclosed volume, wherein when the first inflatable portion is inflated an exterior surface of the outboard panel faces towards the window glass, and wherein at least 50%, preferably at least 60%, most preferably at least 70% of the area of the exterior surface of the outboard panel is in spaced alignment with an opposing surface of the window glass. 100% of the area of the exterior surface of the outboard panel can be in spaced alignment with an opposing and inboard surface of the window glass.

This embodiment of the invention relates to an airbag wherein part of the first inflatable portion is, when inflated, still in contact with the window glass, rather than in spaced alignment.

The term “horizontal mid-line” means, in this specification and in this context, a horizontal line drawn through the midpoint on the vertical axis of the exterior surface of the outboard panel when the inflatable portion is inflated.

The horizontal mid-line of the exterior surface of the outboard panel when the inflatable portion is inflated may be at least 5 cm, preferably at least 10 cm, most preferably at least 15 cm from any point on the opposing and inboard surface of the window glass. The horizontal mid-line of the exterior surface of the outboard panel when the inflatable portion is inflated may be no more than 30 cm, preferably no more than 25 cm from any point on the opposing and inboard surface of the window glass.

The exterior surface of the outboard panel may be configured to adopt, when the first inflatable portion is inflated, a concave profile with respect to the opposing and inboard surface of the window glass when viewed in a plane perpendicular to the opposing and inboard surface of the window glass. Thus the outboard panel curves away from the opposing and inboard surface of the window glass.

In some embodiments, the concave profile of the exterior surface of the outboard panel is achieved by ensuring that the first vertical length of the outboard panel is less than the second vertical length of the inboard portion.

In some embodiments, the concave profile of the exterior surface of the outboard panel is achieved by including one or more horizontal pleats, or folds, into the outboard panel thereby to, in effect, render the first vertical length of the outboard panel less than the second vertical length of the inboard panel.

The pleats can be grouped together or can be discrete and separated. For example, an airbag can comprise one or more pleats grouped together when the airbag is inflated in front of one pane of window glass and another one or more pleats grouped together in front of a neighboring pane of window glass.

In some embodiments, the concave profile of the exterior surface of the outboard panel is achieved by the airbag additionally comprising at least one tether, the at least one tether comprising a first and a second end, wherein:

the first end is attached to a top of the airbag and the second end is attached to a bottom of the airbag, or the first end is attached to a top of the airbag and the second end is attached to a sill of the door when the airbag is deployed from the door, or the first end attached to the roof and the second end attached to a bottom of the airbag when the airbag is deployed from the roof,

wherein the length of the tether is less than the length from the top to the bottom of the airbag when untethered.

The tether in all three aforementioned scenarios describes a chord between the two attachment points. It has been observed that the tether acts as a structural member for the airbag which when inflated has a greater level of resistance to impact.

The term “fluid communication”, in this specification, means that gas may pass between, in the particular context in which the term is used, between the first inflatable portion and the one or more additional inflatable portions.

In another embodiment of the invention, the first inflatable portion, also referred to herein as the cushion, additionally comprises one or more additional inflatable portions, also referred to herein as a spacer, in fluid communication with the first inflatable portion, the one or more additional inflatable portions configured, when inflated, to position the first inflatable portion in spaced alignment with the window glass.

The term “juxtaposed” means, in this specification, on, around or adjacent.

The term “distal” means, in this specification, that the additional inflatable portions are positioned when the airbag is inflated away from the roof or the passenger door of the motor vehicle from which the airbag is deployed and are able to contact the sill (upper edge) of the door when the airbag is deployed from the roof, or the top of the door frame when the airbag is deployed from the door, thereby to position the first inflatable portion in spaced alignment with the window glass.

The one or more additional inflatable portions or spacers may be juxtaposed to the exterior surface of the outboard panel, and distal from the roof when the airbag is deployed from a roof of the motor vehicle. Alternatively, the inflatable portions may be distal from the door when the airbag is deployed from a passenger door of the motor vehicle thereby to position the first inflatable portion in spaced alignment with the window glass.

The one or more additional inflatable portions can be in the form, when inflated:

of one or more horizontal bars; or a plurality of fingers arranged along a substantially horizontal line.

The term “finger”, in this specification, includes cone-shaped or bollard-shaped.

The one or more additional inflatable portions can be in the form, when inflated, of two, or three, or four, or five, or six fingers.

The invention is now described in more detail with reference to:

### BRIEF DESCRIPTION OF THE DRAWINGS

FIGS. 1A, 1B, and 1C which illustrate a first embodiment of a side curtain airbag;

FIGS. 2A and 2B which illustrate a second embodiment of a side curtain airbag;

FIGS. 3A, 3B, and 3C which illustrate a third embodiment of a side curtain airbag; and

FIGS. 4A and 4B which illustrate a fourth embodiment of a side curtain airbag.

### DETAILED DESCRIPTION

The manufacture of airbags is known to the skilled person. Airbags are manufactured from a flexible but airtight fabric such as nylon or polyester, and operate with a sensor which triggers a gas inflator to inflate the airbag under collision conditions. All airbags have vents which allow the gas to escape after deployment.

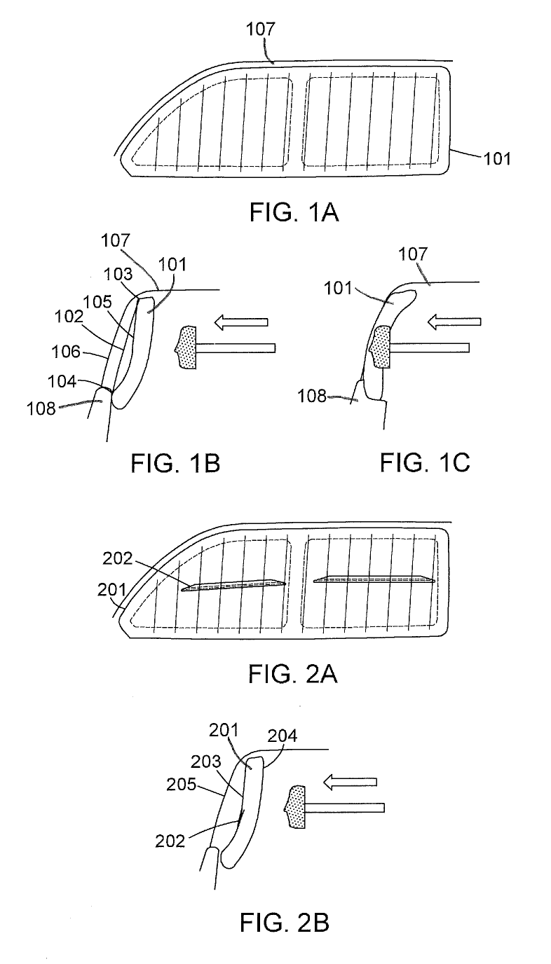

FIGS. 1A to 1C illustrate a first example of the invention wherein the side-curtain airbag comprises a first inflatable portion 101 and a tether 102 thereby the exterior surface of the outboard panel 105 of the first inflatable portion 101 adopts a concave profile with respect to the opposing and inboard surface of the window glass 106 when viewed (as in FIG. 1B) in a plane perpendicular to the opposing and inboard surface of the window glass. The airbag extends vertically between a roof 107 and a sill of a door 108 located immediately below the window glass 106.

FIG. 1A illustrates a side-curtain airbag when inflated. The inflated first inflatable portion 101 in FIG. 1A covers the side window glass.

FIG. 1B is a side profile of the airbag in FIG. 1A illustrating the airbag when inflated with a tether 102 comprising a first 103 and a second 104 end, wherein the first end is attached to a top end of the airbag and the second end is attached to a bottom end of the airbag, and wherein the length of the tether is less than the length from the top end to the bottom end of the airbag when untethered.

FIG. 1C illustrates operation of the airbag in a side collision impact reducing lateral head movement towards the side window glass and ejection from the motor vehicle.

FIGS. 2A and 2B illustrate another example of the invention wherein the side-curtain airbag comprises a first inflatable portion 201 and horizontal pleats 202 in the outboard panel 203 thereby to effectively reduce the length of the outboard panel from top to bottom measured along its surface when the airbag is inflated to less than that for the inboard panel 204 and produce a concave profile of the outboard panel 203 with respect to the opposing surface of the window glass 205 when viewed (as in FIG. 2B) in a plane perpendicular to the opposing surface of the window glass.

FIG. 2A illustrates a side-curtain airbag when inflated comprising a first inflatable portion 201 and two groups of horizontal pleats 202 in the outboard panel 203 of the airbag, each group comprising more than one pleat.

FIG. 2B is a side profile of the airbag in FIG. 2A illustrating the airbag when inflated with a horizontal pleat 202.

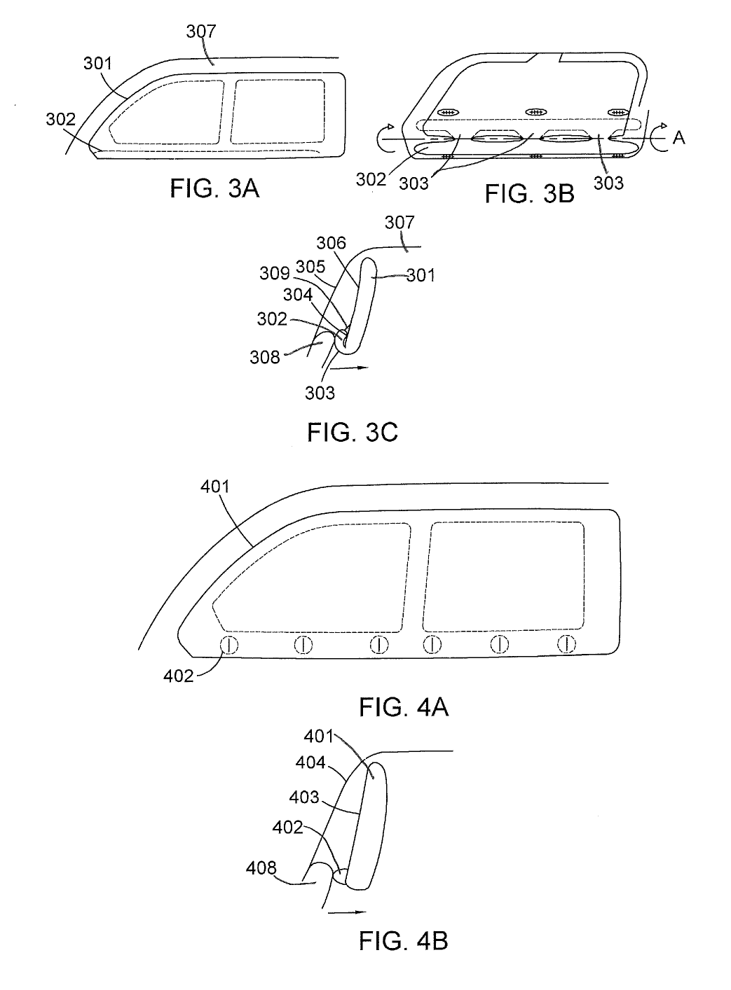

In a third example of the invention as illustrated in FIGS. 3A to 3C, the side-curtain airbag deploys from the roof 307 of the motor vehicle and comprises a first inflatable portion or cushion 301 and an additional inflatable portion or spacer in the form of a single horizontal bar 302 at a distal end from the roof and in fluid communication with the cushion 301 and configured, when inflated, to contact the door 308 and thereby position the cushion in spaced alignment with the window glass 305.

In particular, FIG. 3A illustrates a side-curtain airbag when inflated comprising a cushion 301 and a spacer in the form of a single horizontal bar 302 in fluid communication with the cushion.

FIG. 3B is another view of the side-curtain airbag of FIG. 3A illustrating the fluid communication between the cushion 301 and the spacer 302 takes the form of several channels 303. The spacer 302 is rotated around a horizontal axis A defined by the channels 303 to lie against the exterior surface of the outboard panel 306 of the cushion 301 thereby, when the airbag is inflated, to contact the sill of the door 308 and thereby position the cushion 301 in spaced alignment with the window glass 305.

FIG. 3C is a side profile of the airbag in FIG. 3A illustrating the airbag when inflated with the spacer 302 rotated around a horizontal axis defined by the channels 303 to lie against the exterior surface of the outboard panel 306 of the cushion 301. The spacer 302 is shown secured in place by stitching 309 to the outboard panel 306. Alternative means for securing the spacer 302 against the exterior surface of the outboard panel 306 of the cushion 301 includes adhesive. FIG. 3C illustrates that the spacer 302 rests against the sill of the door 308 thereby to position the cushion 301 in spaced alignment with the window glass 305.

FIGS. 4A and 4B illustrate a fourth example of the invention wherein the side-curtain airbag, which is deployed from the roof of the motor vehicle, comprises a cushion 401 and one or more spacers in the form, when inflated, of a plurality of fingers 402 in fluid communication with the cushion.

FIG. 4A illustrates a side-curtain airbag in the inflated state covering the side window glass, the airbag comprising a cushion 401 and one or more spacers in the form, when inflated, of a plurality of fingers 402 arranged along a substantially horizontal line towards the bottom end of the airbag. The one or more spacers protrude from the exterior surface 403 of the outboard panel of the cushion 401 thereby to position the cushion in spaced alignment with the window glass 404.

FIG. 4B is a side profile of the airbag in FIG. 4A. It can be seen that the cushion 401 is in spaced arrangement with the window glass 404 by virtue the one or more spacers 402 protruding from the exterior surface 403 of the outboard panel of the cushion 401 and impinging on the sill of the door 408 pushing the cushion inboard into the motor vehicle cabin.

It can therefore be seen that in all the aforementioned examples, the cushion, when inflated, is in spaced alignment with the window glass.

It will further be appreciated by those skilled in the art that although the invention has been described by way of example with reference to several embodiments it is not limited to the disclosed embodiments and that alternative embodiments could be constructed without departing from the scope of the invention as defined in the appended claims.

What is claimed is:

1. A side-curtain airbag for a motor vehicle, comprising:
a first inflatable portion deployable downwardly from a roof of the vehicle and configured when inflated to cover at least a portion of a side window; and
an additional inflatable portion in fluid communication with the first inflatable portion and configured, when inflated, to contact a door below the window and position at least a portion of the first inflatable portion in spaced relationship with the side window.

2. The side-curtain airbag of claim 1, wherein the additional inflatable portion comprises at least one horizontal bar.

3. The side-curtain airbag of claim 2, wherein the at least one horizontal bar is in fluid communication with the first inflatable portion by a plurality of channels.

4. The side-curtain airbag of claim 3, wherein the at least one horizontal bar when inflated is rotated about an axis defined by the plurality of channels to lie against an exterior surface of the first inflatable portion.

5. The side-curtain airbag of claim 4, wherein an edge of the at least one horizontal bar distal from the plurality of channels is secured to the first inflatable portion by stitching.

6. The side-curtain airbag of claim 1, wherein the additional inflatable portion comprises a plurality of fingers arranged along a substantially horizontal line adjacent a lower end of the additional inflatable portion.

7. A side-curtain airbag for a motor vehicle, comprising:
a first inflatable portion deployable from a first vehicle structure adjacent to a first edge of a side window and configured when inflated to cover at least a portion of the side window; and
at least one additional inflatable portion in fluid communication with an end of the first inflatable portion distal from the first vehicle structure and configured, when inflated, to contact a second vehicle structure adjacent to a second edge of the side window opposite from the first edge of the side window and position at least a portion of the first inflatable portion in spaced relationship with the side window.

8. The side-curtain airbag of claim 7, wherein the first vehicle structure is a roof of the vehicle and the second vehicle structure is a sill of a door below the side window.

9. The side-curtain airbag of claim 7, wherein the additional inflatable portion comprises at least one horizontal bar.

10. The side-curtain airbag of claim 9, wherein the at least one horizontal bar is in fluid communication with the first inflatable portion by a plurality of channels.

11. The side-curtain airbag of claim 10, wherein the at least one horizontal bar when inflated is rotated about an axis defined by the plurality of channels to lie against an exterior surface of the first inflatable portion.

12. The side-curtain airbag of claim 11, wherein an edge of the at least one horizontal bar distal from the plurality of channels is secured to the first inflatable portion by stitching.

13. The side-curtain airbag of claim 7, wherein the additional inflatable portion comprises a plurality of fingers arranged along a substantially horizontal line.

14. A side-curtain airbag for a motor vehicle, comprising:
an inflatable cushion deployable downwardly from a roof of the vehicle and configured when inflated to cover at least a portion of a side window; and
an inflatable spacer in fluid communication with an end of the cushion distal from the roof and configured, when inflated, to contact a door below the window and position the cushion in spaced relationship with the side window.

15. The side-curtain airbag of claim 14, wherein the spacer comprises at least one horizontal bar.

16. The side-curtain airbag of claim 15, wherein the at least one horizontal bar is in fluid communication with the cushion by a plurality of channels.

17. The side-curtain airbag of claim 16, wherein the at least one horizontal bar when inflated is rotated about an axis defined by the plurality of channels to lie against an exterior surface of the cushion.

18. The side-curtain airbag of claim 17, wherein an edge of the at least one horizontal bar distal from the plurality of channels is secured to the cushion by stitching.

19. The side-curtain airbag of claim 14, wherein the spacer comprises a plurality of fingers arranged along a substantially horizontal line adjacent a lower end of the cushion.
